(19) United States
(12) Patent Application Publication
(10) Pub. No.: US 2016/0097341 A1
(43) Pub. Date: Apr. 7, 2016

(54) CYLINDER HEAD

(71) Applicant: TOYOTA JIDOSHA KABUSHIKI KAISHA, Toyota-shi (JP)

(72) Inventors: Masahiro FUJIWARA, Okazaki-shi (JP); Hiroki HARA, Nagoya-shi (JP)

(73) Assignee: TOYOTA JIDOSHA KABUSHIKI KAISHA, Toyota-shi (JP)

(21) Appl. No.: 14/867,187

(22) Filed: Sep. 28, 2015

(30) Foreign Application Priority Data
Oct. 3, 2014 (JP) 2014-205025

(51) Int. Cl. F02F 1/24; F02F 11/00

(52) U.S. Cl. CPC F02F 1/242; F02F 11/002

(57) ABSTRACT

A cylinder head located between a cylinder block and a head cover includes a cam chamber arranged in an upper portion of the cylinder head and opening toward the head cover, a projection projecting from a bottom surface of the cam chamber toward the head cover and including an injector insertion hole, and a seating surface arranged in the bottom surface of the cam chamber and receiving a valve spring. The projection includes a top surface defining an injector seal surface around the injector insertion hole. The projection includes a first portion and a second portion separated from the seating surface by different distances along the bottom surface. The distance of the second portion from the seating surface is longer than that of the first portion. A side surface of the first portion is set to have a smaller draft angle than a side surface of the second portion.

### BACKGROUND OF THE INVENTION

The present invention relates to a cylinder head.

Japanese Laid-Open Patent Publication No. 2003-293851 discloses a cylinder head for a direct injection diesel engine, which directly injects fuel into cylinder bores.

As shown in FIG. 7, the cylinder head described in Japanese Laid-Open Patent Publication No. 2003-293851 includes cam chambers 50 having upper openings. The cam chambers 50 share an injector boss 51, which is a tubular projection and projects from bottom surfaces 50A of the cam chambers 50 toward an upper side of the cylinder head. The injector boss 51 includes an injector insertion hole 52 extending along an axis of the injector boss 51. The injector insertion hole 52 receives an injector.

The injector boss 51 includes a top surface defining an injector seal surface 51A. A seal member, which limits leakage of combustion gas and the like from the injector insertion hole 52, is arranged on the injector seal surface 51A. Side surfaces 51B of the injector boss 51 extend at draft angles of the inserts used to mold the cam chambers 50. More specifically, the injector boss 51 is formed so that the cross-sectional area orthogonal to the axis increases toward the bottom surfaces 50A of the cam chambers 50.

Each bottom surface 50A includes a seating surface 53, which receives a valve spring, near the injector boss 51. After the cylinder head is casted, the cylinder head undergoes machining or the like to form the seating surfaces 53.

### SUMMARY OF THE INVENTION

When the included valve angle of an intake valve and an exhaust valve is small and the distance between the valves is short, the seating surfaces 53 for the valve springs are located proximate to the injector insertion hole 52. Thus, the injector boss 51 may partially overlap with the bottom surfaces 50A of the cam chambers 50 where the seating surfaces 53 are formed. In such a case, when machining the seating surfaces 53, it is necessary to partially cut away the injector boss 51. This lowers the machinability of the seating surface 53. To avoid interference with the seating surfaces 53, the diameter of the injector boss 51 may be decreased. This would, however, decrease the area of the top surface that defines the injector seal surface 51A. Thus, it would become difficult to ensure the sealing properties.

It is an object of the present invention to provide a cylinder head that ensures the area of an injector seal surface without lowering the machinability of the valve spring seating surfaces even when the injector insertion hole and the seating surface are located proximate to each other.

One aspect of the present disclosure is a cylinder head located between a cylinder block and a head cover. The cylinder head includes a cam chamber, a projection, and a seating surface. The cam chamber is arranged in an upper portion of the cylinder head and opens toward the head cover. The projection projects from a bottom surface of the cam chamber toward the head cover and includes an injector insertion hole. The seating surface is arranged in the bottom surface of the cam chamber and receives a valve spring. The projection includes a top surface that defines an injector seal surface around the injector insertion hole. The projection includes a first portion and a second portion that are separated from the seating surface by different distances along the bottom surface. The distance of the second portion from the seating surface is longer than that of the first portion from the seating surface. A side surface of the first portion is set to have a smaller draft angle than a side surface of the second portion.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional view showing a portion of a direct injection diesel engine to which one embodiment of a cylinder head is applied;

FIG. 2 is a partial plan view showing the cylinder head of FIG. 1;

FIG. 3 is a partial perspective view showing cam chambers in the cylinder head of FIG. 1;

FIG. 4 is a cross-sectional view of the cylinder head taken along line 4-4 of FIG. 2;

FIG. 5 is a cross-sectional view of the cylinder head taken along line 5-5 of FIG. 2;

FIGS. 6A to 6C are diagrams showing the procedures for casting the cylinder head of FIG. 1; and

FIG. 7 is a cross-sectional view of a conventional cylinder head.

### DETAILED DESCRIPTION OF THE PREFERRED EMBODIMENTS

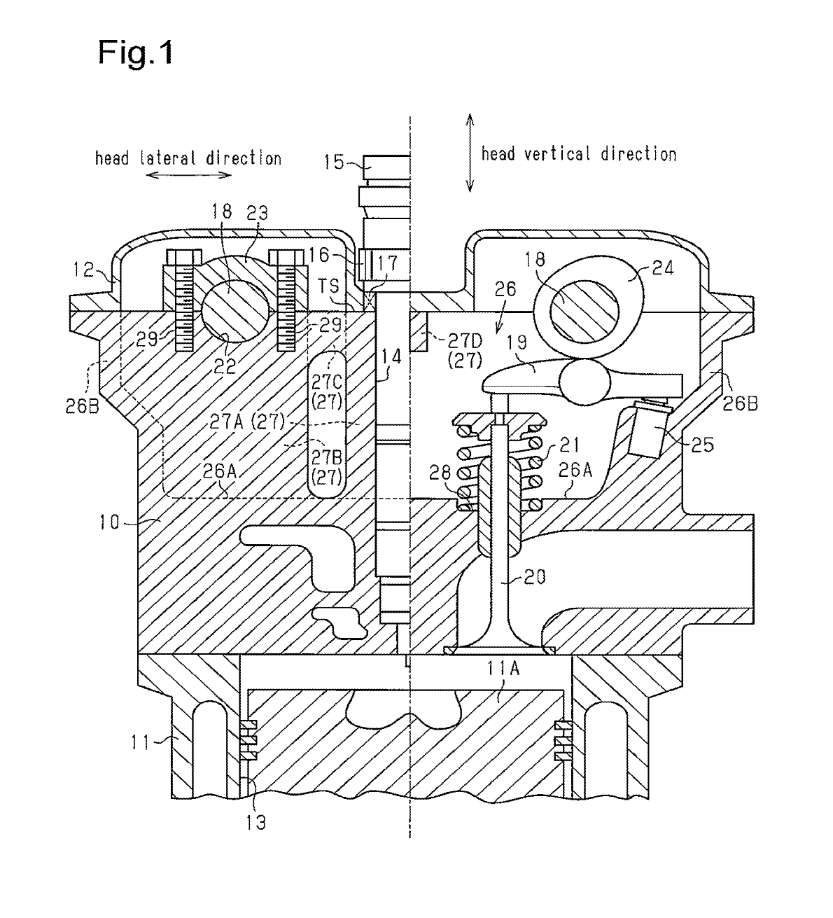

Embodiments of a cylinder head will now be described in detail with reference with FIGS. 1 to 6. The cylinder head of the present embodiment is applied to a direct injection diesel engine, which directly injects fuel into cylinders.

As shown in FIG. 1, the present embodiment of a cylinder head 10 is applied to a direct injection diesel engine that includes a cylinder block 11, which is located below the cylinder head 10, and a head cover 12, which is located above the cylinder head 10. The cylinder block 11 includes cylinders, each of which defines a cylinder bore 13 accommodating a movable piston 11A. In the description, the direction extending from the cylinder head 10 toward the cylinder block 11 is defined as the “lower direction (first direction)”, and the direction extending from the cylinder head 10 toward the head cover 12 is defined as the “upper direction (second direction)”. Additionally, when viewing the cylinder head 10 from above, the direction in which the cylinders are laid out is defined as the “head longitudinal direction”, and the direction orthogonal to the head longitudinal direction is defined as the “head lateral direction”.

In a portion of the cylinder head 10 located immediately above each cylinder bore 13, an injector insertion hole 14 extends through the cylinder head 10 in the vertical direction. Each injector insertion hole 14 receives an injector 15 from above. Further, injector holders 16, which are fastened to the cylinder head 10 with bolts, restrict the removal of the injectors 15 from the injector insertion holes 14. A seal member 17 is arranged around the upper open end of each injector insertion hole 14. The seal member 17 limits leakage of combustion gas through the injector insertion hole 14.

The upper portion of the cylinder head 10 includes a cam chamber 26, which opens toward the head cover 12. The cam chamber 26 includes a valve drive mechanism, which is used for the intake of air into and the exhaust of gas out of each cylinder bore 13.

The valve drive mechanism includes two camshafts 18, namely, one intake camshaft 18 and one exhaust camshaft 18.

The valve drive mechanism also includes a plurality of rocker arms 19, a plurality of poppet valves 20 (intake valve and exhaust valve), and a plurality of valve springs 21, for each cylinder. In the direct injection diesel engine, each cylinder is provided with two poppet valves 20, namely, an intake poppet valve 20 and an exhaust poppet valve 20. Additionally, in the direct injection diesel engine, the included valve angle of the intake and exhaust poppet valves 20 is substantially “zero”.

Each camshaft 18, which drives the poppet valves 20 so that the poppet valves 20 open and close, includes cams 24 respectively arranged for the poppet valves 20. The upper portion of the cylinder head 10 includes cam carriers 22 each having the form of a semicircular recess. The camshafts 18 are rotationally arranged between the cam carriers 22 and cam caps 23, which are located above the cam carries 22 and fastened to the cylinder head 10 with bolts.

The rocker arms 19 are located below the corresponding cams 24 in the cam chamber 26. Each rocker arm 19 includes one end pivotally supported by a lash adjuster 25, which is fixed to the cylinder head 10, and another end, of which the lower surface is in contact with the upper end of the corresponding poppet valve 20. Each poppet valve 20 is urged in the upper direction, or a valve closing direction, by a valve spring 21. The rocker arm 19 is pushed upward by the poppet valve 20, which is urged upward by the valve spring 21. Thus, each rocker arm 19 is pressed against the corresponding cam 24.

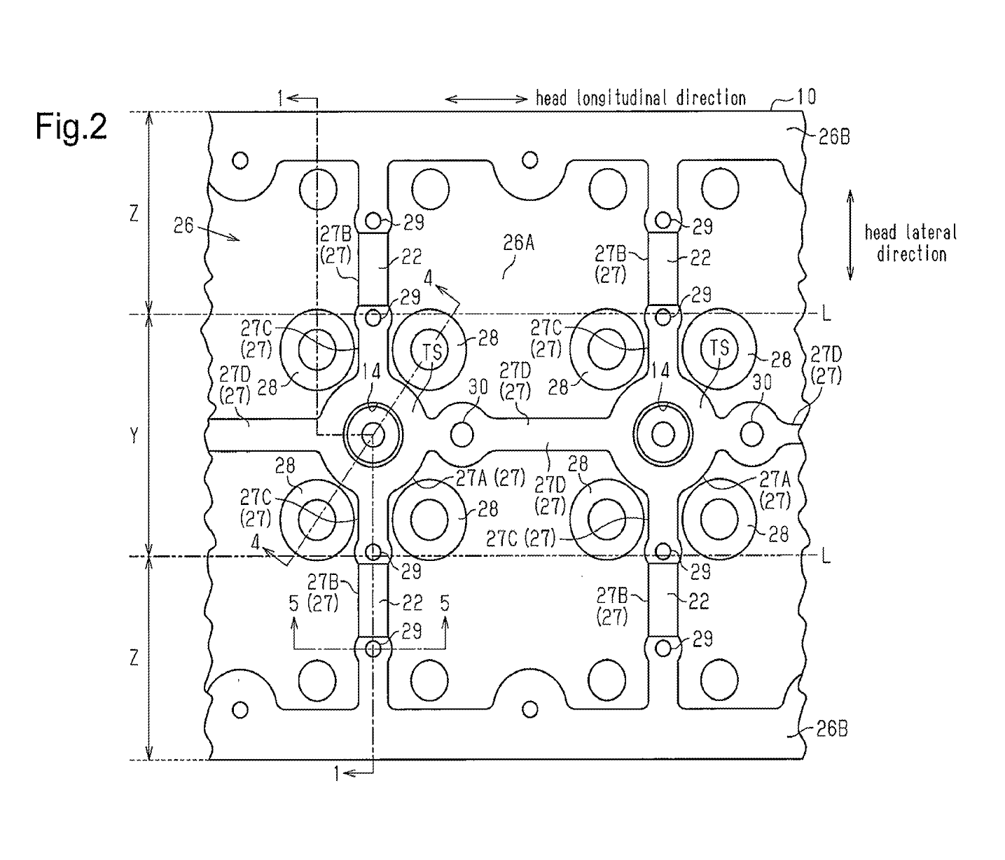

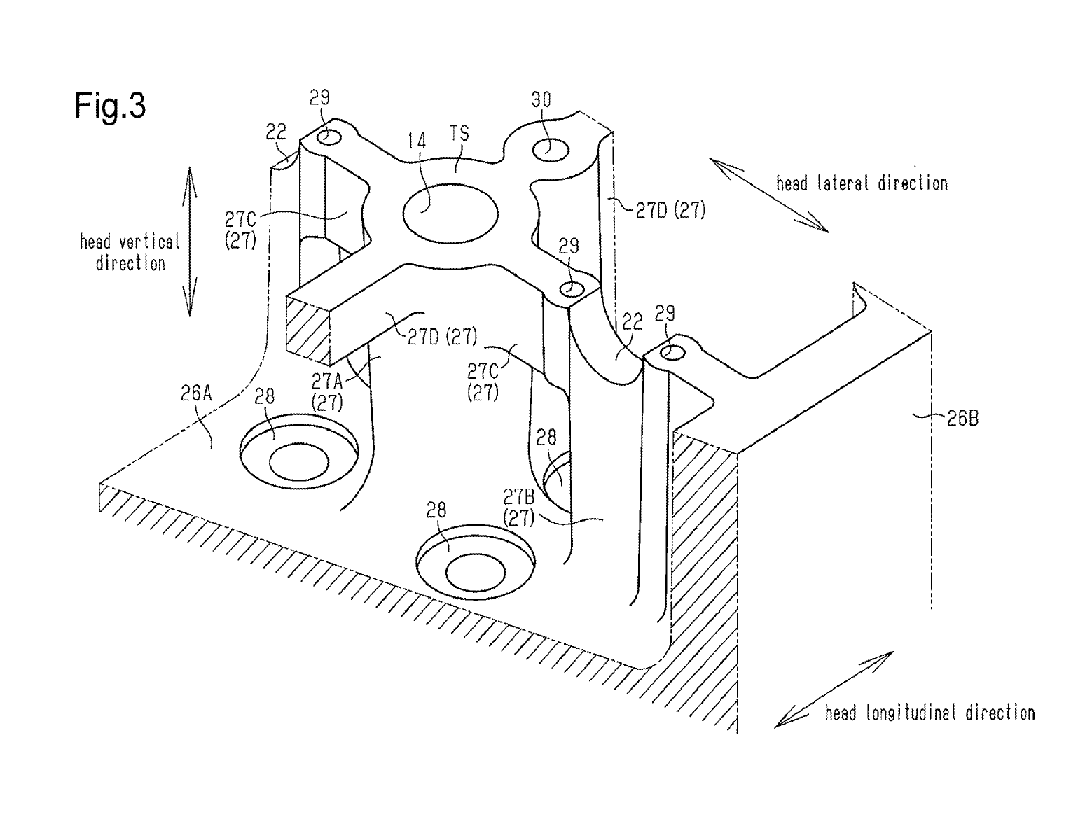

FIG. 2 is a plan view showing the structure of a portion of the cylinder head 10. FIG. 3 is a perspective view showing the structure of a portion of the cam chamber. The cross-section of the direct injection diesel engine shown in FIG. 1 corresponds to the cross-section of the cylinder head 10 taken along line 1-1 in FIG. 2.

The cam chamber 26 of the cylinder head 10 includes a projection 27 projecting upward from a bottom surface 26A of the cam chamber 26. The projection 27 includes injector bosses 27A, cam carrier portions 27B, and ribs 27C, 27D. In the cylinder head 10, the projection 27 is arranged so that a top surface of the projection 27 is flush with a top surface (upper end surface) of the cylinder head 10.

Each injector boss 27A, which is a tubular portion accommodating an injector 15, includes an injector insertion hole 14 extending along an axis of the injector boss 27A. The injector 15 is inserted into the injector insertion hole 14. The top surface of each injector boss 27A defines an injector seal surface TS, which contacts a seal member 17.

The cam carrier portions 27B, each of which is a portion to which a cam cap 23 is coupled, are arranged at opposite sides of each injector boss 27A in the head lateral direction. Each cam carrier portion 27B includes a cam carrier 22 and two bolt holes 29, which are used to fix the cam cap 23. In the cylinder head 10, the outer side of each cam carrier portion 27B in the head lateral direction is connected to an outer wall 26B of the cam chamber 26.

Each rib 27C is a portion connecting an injector boss 27A and a cam carrier portion 27B. Each rib 27D is a portion connecting injector bosses 27A of adjacent cylinders. The ribs 27D include bolt holes 30, which are used to fix the injector holders 16.

In the bottom surface 26A of the cam chamber 26, four seating surfaces 28, which receive the valve springs 21, are arranged around each injector boss 27A. After the cylinder head 10 is casted, the seating surfaces 28 are machined by cutting away the bottom surface 26A of the cam chamber 26. As described above, in the cylinder head 10, the included valve angle of the intake valve and the exhaust valve is substantially “zero”. Thus, the seating surfaces 28 of the valve springs 21 are arranged at a relatively small distance from the injector insertion holes 14.

When casting the cylinder head 10, the cam chamber 26 and the projection 27, which is arranged in the cam chamber 26, are formed using inserts placed in a casting mold. In general, such inserts are removed from the mold upward, or toward an opening of the cam chamber 26. Thus, slopes (draft angles) are set on side surfaces of the cam chamber 26 and the projection 27 so that the inserts are easily removed upward from the mold. More specifically, the side surfaces of the cam chamber 26 and the projection 27 are generally formed to have positive draft angles. The draft angle is the inclination angle relative to the mold removal direction (upper direction).

As described above, in the cylinder head 10 of the present embodiment, the seating surfaces 28 of the valve springs 21 are formed at locations close to the injector insertion holes 14. Thus, when an injector boss 27A is formed so that a sufficient area is ensured for the top surface, which defines the injector seal surface TS, and the side surface has a sufficient draft angle, the injector boss 27A would partially overlap with the bottom surface 26A of the cam chamber 26 where the seating surfaces 28 are formed. In such a case, when the seating surfaces 28 are machined, the side surface of the injector boss 27A would have to be partially removed. This would lower the machinability of the seating surfaces 28.

In this regard, in the present embodiment, the projection 27 includes side surfaces of a portion (first portion) separated from the seating surfaces 28 by a short distance along the bottom surface 26A and side walls of a portion (second portion) separated from the seating surfaces 28 by a long distance along the bottom surface 26A. The side surfaces of the first portion have a smaller draft angle than the side surfaces of the second portion. More specifically, in FIG. 2, portion Y, which is located at an inner side of two parting lines L in the head lateral direction, is where the side surfaces of the projection 27 have a smaller draft angle, and portions Z, which are located at outer sides of the two parting lines L in the head lateral direction, is where the side surfaces of the projection 27 have a larger draft angle. That is, portion Y of the projection 27, which is located at the inner side of the two parting lines L in the head lateral direction, corresponds to the first portion, and portions Z of the projection 27, which are located at the outer sides of the two parting lines L in the head lateral direction, correspond to the second portion.

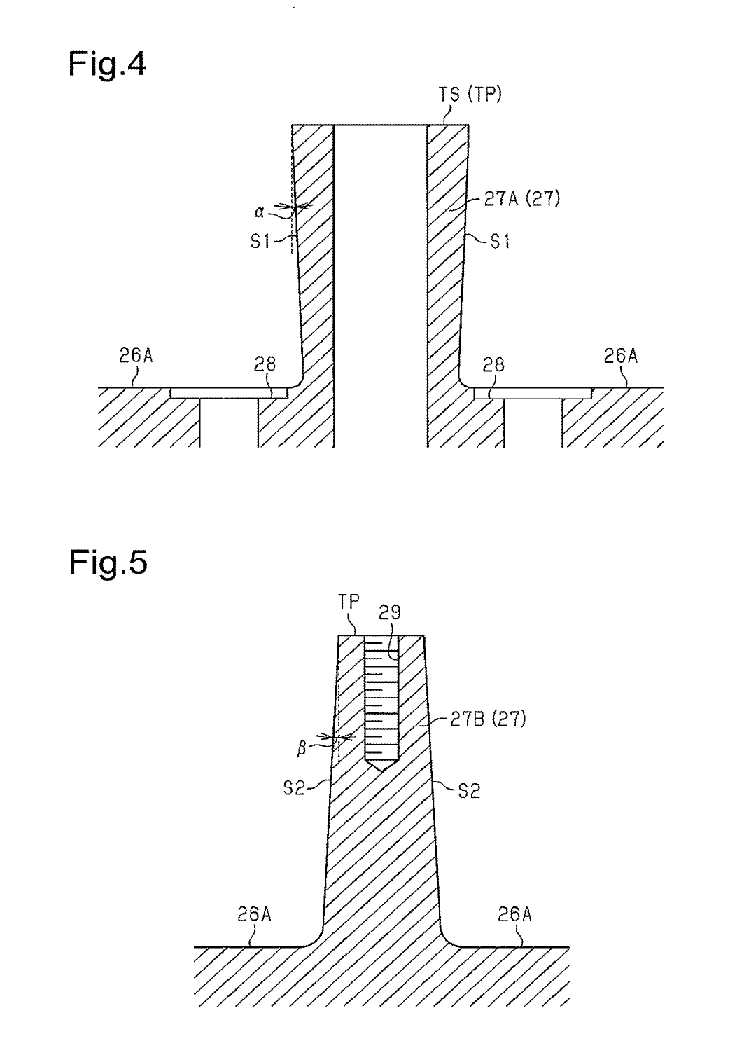

FIG. 4 is a cross-sectional view showing the structure of an upper portion of the cylinder head 10 taken along line 4-4 in FIG. 2. FIG. 4 shows an injector boss 27A that is located in portion Y of the projection 27, which is located at the inner side of the two parting lines L in the head lateral direction. As shown in the injector boss 27A of FIG. 4, a side surface S1 of the projection 27 in the portion Y is formed at a draft angle a that is negative with respect to the upward direction in which the mold is removed.

FIG. 5 is a cross-sectional view showing the structure of an upper portion of the cylinder head 10 taken along line 5-5 in FIG. 2. FIG. 5 shows the cross-section of a cam carrier portion 27B that is located in portion Z of the projection 27, which is located at the outer side of one of the two parting lines L in the head lateral direction. As shown in the cam carrier portion 27B of FIG. 5, a side surface S2 of the projection 27 in the portion Z is formed at a draft angle 8 that is positive with respect to the upward direction in which the mold is removed.

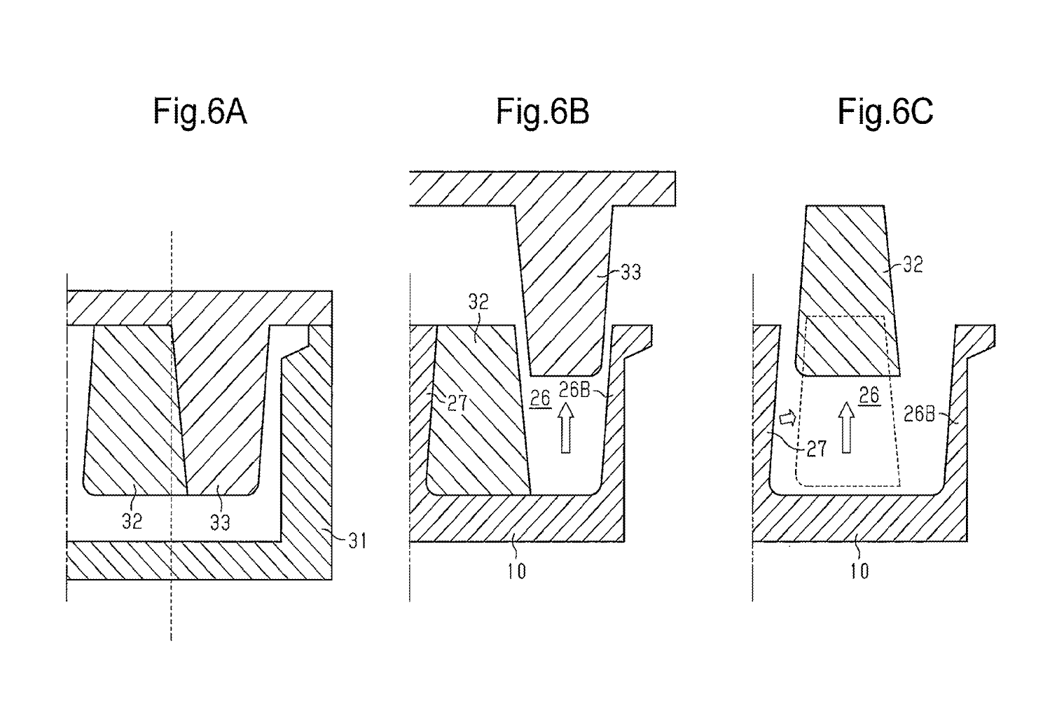

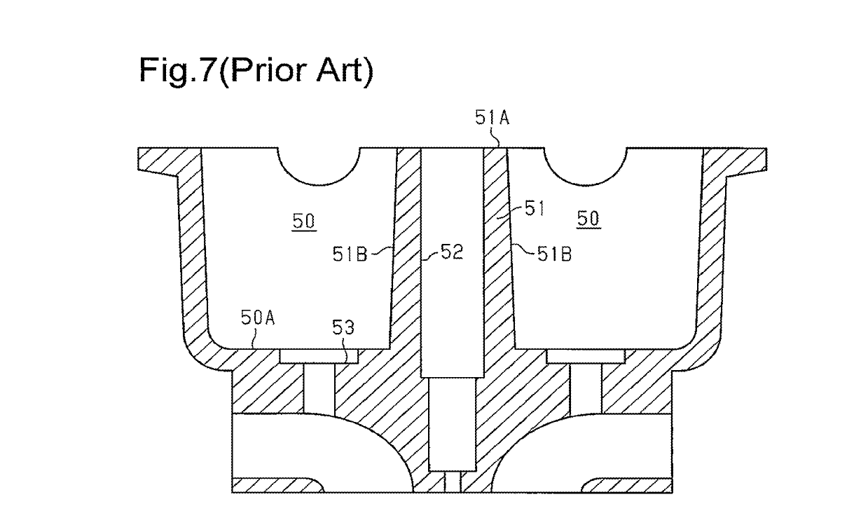

FIGS. 6A, 6B, and 6C show the procedures for casting the cylinder head 10. After the casting, the cylinder head 10 undergoes various types of machining to form the injector insertion holes 14, the seating surfaces 28, the bolt holes 29, 30, and the like.

As shown in FIG. 6A, the casting of the cylinder head 10 uses an outer mold 31, which forms the outer side of the cylinder head 10, and an insert, which forms the cam chamber 26. The insert is separated into an inner insert 32 and an outer insert 33. The inner insert 32 forms portion Y of the cam chamber 26, which is located at the inner side of the parting lines L in the head lateral direction. The outer insert 33 forms portions Z of the cam chamber 26, which are located at the outer sides of the parting lines L in the head lateral direction. In the cam chamber 26, the inner insert 32 forms a portion in which a side surface of the projection 27, which is located in the cam chamber 26, has a negative draft angle with respect to the upward direction in which the mold is removed. Additionally, in the cam chamber 26, the outer insert 33 forms a portion in which a side surface of the projection 27, which is located in the cam chamber 26, has a positive draft angle with respect to the upward direction in which the mold is removed. In the above manner, the interior of the cam chamber 26 is partitioned into a plurality of regions by the projection 27. Thus, the inner insert 32 and the outer insert 33 are each separated into a plurality of parts, accordingly.

After the casting, the inner insert 32 and the outer insert 33 are sequentially removed from the mold. The outer insert 33 forms a portion of the cam chamber 26 and side surfaces of the projection 27 with a positive draft angle with respect to the upward direction in which the mold is removed. Also, an insert separation surface of the outer insert 33 has a positive draft angle with respect to the upward direction in which the mold is removed. Thus, as shown in FIG. 6B, the outer insert 33 is removed upward. After the outer insert 33 is removed, open space is formed in the cam chamber 26. Thus, as shown in FIG. 6C, to remove the inner insert 32, the inner insert 32 moved in the horizontal direction and then removed upward.

The present embodiment of the cylinder head 10 having the above structure has the advantages described below.

The cylinder head 10 of the present embodiment includes portion Y that is separated by a short distance from the seating surfaces 28, which receives the valve springs 21. Portion Y includes the injector bosses 27A. In portion Y, the draft angle a of side surfaces S1 of the projection 27 is set to be small. More specifically, in portion Y, the side surfaces of the projection 27 are formed to have a negative draft angle (α<0). Thus, interference may be avoided between the projection 27 and the locations where the seating surfaces 28 are formed in the bottom surface 26A of the cam chamber 26 while limiting decreases in the areas of the injector seal surfaces TS that would occur when avoiding such interference. Consequently, even when the injector insertion holes 14 are located proximate to the seating surfaces 28, the machinability of the seating surfaces 28 may be unaffected while ensuring the areas of the injector seal surfaces TS. In particular, even when the seating surfaces 28 are formed at locations extremely close to the injector insertion holes 14, the side surfaces of the projection 27 located in portion Y, which is separated from the seating surfaces 28 by a short distance along the bottom surface 26A of the cam chamber 26, have a negative draft angle. This ensures that the injector seal surfaces TS have sufficient areas while ensuring the machinability of the seating surfaces 28.

In the casting of the cylinder head 10, when the cam chamber 26 is formed using the insert placed in the mold, the insert is removed upward, or toward the opening of the cam chamber 26. In this case, when portion Y having a small draft angle exists in the cam chamber 26, removal of the insert from the mold would be difficult. In this regard, in portion Z, which is separated from the seating surfaces 28 by a long distance along the bottom surface 26A, the draft angle β of a side surface S2 of the projection 27 is set to be large. Thus, portion Y, which has a small draft angle, is limited to a portion that needs to obtain the areas of the injector seal surfaces TS. This facilitates removal of the insert used to form the cam chamber 26. More specifically, in portion Z, the side surfaces S2 of the projection 27 are formed to have a positive draft angle (β>0). Thus, even when the projection 27 includes a portion having a negative draft angle, the insert for forming the cam chamber 26 may be formed in separate parts to facilitate the removal of the insert from the mold.

It should be apparent to those skilled in the art that the present invention may be embodied in many other specific forms without departing from the scope of the invention. Particularly, it should be understood that the present invention may be embodied in the following forms.

The number and location of the injector bosses 27A and the cam carrier portions 27B may be changed in accordance with the location of cylinders and the structure of the valve drive mechanism in the applied direct injection diesel engine.

In the above embodiment, the projection 27 is arranged so that a top surface TP of the projection 27 is flush with the top surface of the cylinder head 10. Instead, the projection 27 may be formed so that the top surface TP of the projection 27 is located at a position lower than the top surface of the cylinder head 10.

In the projection 27 of the above embodiment, the injector boss 27A of each cylinder is integrally coupled to the cam carrier portions 27B by the ribs 27C, 27D. Instead, the ribs 27C, 27D may be partially or entirely omitted. In this case, the injector boss 27A and the cam carrier portions 27B may be formed separately. Additionally, for example, when the cam carriers 22 are not formed integrally with the cylinder head 10, the cam carrier portions 27B may be omitted from the projection 27. In any case, the side surface of a projection projecting upward from the bottom surface 26A of the cam chamber 26 may be formed so that a portion separated from the seating surfaces 28 of the valve springs 21 by a short distance has a smaller draft angle than a portion separated from the seating surfaces 28 of the valve springs 21 by a long distance. This ensures the areas of the injector seal surfaces TS while ensuring the machinability of the seating surfaces 28.

In the above embodiment, the projection 27 is formed so that the side surfaces S2 have a negative draft angle in portion Y, which is separated from the seating surfaces 28 by a short distance along the bottom surface 26A, the side surfaces S1 have a positive draft angle in portion Z, which is separated from the seating surfaces 28 by a long distance along the bottom surface 26A. However, in portion Y, the side surfaces S1 of the projection 27 may be formed to have a positive draft angle a as long as the areas of the injector seal surfaces TS and the machinability of the seating surfaces 28 are sufficient. Even in this case, the draft angle a of the side surfaces S1 may be set to be smaller than that of the side surfaces S2 of the projection 27 in the portion Z. This simplifies the removal of the insert for forming the cam chamber 26 as compared to when the entire side surfaces of the projection have small draft angles. Additionally, in this case, depending on the shapes of the cam chamber 26 and the projection 27, the insert may be removed from the mold without separating the insert into parts.

In the above embodiment, the draft angles of the side surfaces of the projection 27 in portion Y, which is located at the inner side of the parting lines L in the head lateral direction, differ from the draft angles of the side surfaces of the projection 27 in portions Z, which are located at the outer sides of the parting lines L in the head lateral direction. Instead, the portions where the side surfaces of the projection 27 have different draft angles may be changed. For example, an injector boss 27A may be divided in the circumferential direction into portions in which side surfaces of the injector boss 27A have different draft angles. Additionally, a side surface of the projection 27 may have a draft angle that changed in three or more steps. Alternatively, a side surface of the projection 27 may have a draft angle that continuously changes in correspondence with the distance from the seating surfaces 28. In any case, the projection 27 may be formed so that a side surface of a portion separated from the seating surfaces 28 by a short distance along the bottom surface 26A has a smaller draft angle than a side surface of a portion separated from the seating the surfaces 28 by a long distance along the bottom surface 26A. This ensures the areas of the injector seal surfaces TS while obtaining the machinability of the seating surfaces 28.

The present examples and embodiments are to be considered as illustrative and not restrictive, and the invention is not to be limited to the details given herein, but may be modified within the scope and equivalence of the appended claims.

1. A cylinder head located between a cylinder block and a head cover, the cylinder head comprising:
a cam chamber arranged in an upper portion of the cylinder head, wherein the cam chamber opens toward the head cover;
a projection that projects from a bottom surface of the cam chamber toward the head cover, wherein the projection includes an injector insertion hole; and
a seating surface arranged in the bottom surface of the cam chamber, wherein the seating surface receives a valve spring, wherein
the projection includes a top surface that defines an injector seal surface around the injector insertion hole, the projection includes a first portion and a second portion that are separated from the seating surface by different distances along the bottom surface,
the distance of the second portion from the seating surface is longer than that of the first portion from the seating surface, and
a side surface of the first portion is set to have a smaller draft angle than a side surface of the second portion.

2. The cylinder head according to claim 1, wherein
the side surface of the first portion has a negative draft angle, and
the side surface of the second portion has a positive draft angle.

3. The cylinder head according to claim 1, wherein the first portion includes at least a part of the projection that includes the injector seal surface.

4. The cylinder head according to claim 1, wherein the projection includes
a tubular injector boss including the injector insertion hole,
a cam carrier portion that supports a camshaft, and
a rib that connects the injector boss and the cam carrier portion.

5. The cylinder head according to claim 4, wherein
the first portion includes the injector boss and the rib, and
the second portion includes the cam carrier portion.
